(19) United States
(12) Patent Application Publication
(10) Pub. No.: US 2010/0191895 A1
(43) Pub. Date: Jul. 29, 2010

(54) SYSTEM, TEST APPARATUS AND RELAY APPARATUS

(75) Inventor: Kazumoto TAMURA, Gunma (JP)

Correspondence Address: Masao Yoshimura, 333 W. El Camino Real, Suite 380, Sunnyvale, CA, 94087, US

(73) Assignee: ADVANTEST CORPORATION, Tokyo (JP)

(21) Appl. No.: 12/712,168

(22) Filed: Feb. 24, 2010

Related U.S. Application Data
(63) Continuation of application No. PCT/JP2007/066554, filed on Aug. 27, 2007.

(51) Int. Cl. G06F 13/14; G06F 12/00

(52) U.S. Cl. 711/100; 711/E12.001

(57) ABSTRACT

There is a system comprising a requesting device including a block generating section which generates an access information block storing access information including a target address of an access target and an access command indicating content to be executed for the access target in each of a plurality of accesses, and a block transmitting section which transmits the generated access information block to a relay apparatus, the relay apparatus including a block receiving section which receives the access information block from the requesting device and an access issuing section which sequentially issues corresponding access to a responding device on the basis of the access information included in the transmitted access information block, and the responding device including an access receiving section which receives each access corresponding to the access information included in the access information block from the relay apparatus and an access processing section which executes an access process for a storage area corresponding to a target address of the received access.

### BACKGROUND

1. Technical Field

The present invention relates to a system, a test apparatus, and a relay apparatus. More particularly, the present invention relates to a system having a requesting device which requests access, a responding device which processes the requested access, and a relay apparatus which relays communication between the requesting device and the responding device, and a test apparatus having a test module which receives and transmits a signal from and to a device under test, a control device which controls the test module, and a relay apparatus which controls communication between the control device and the test module.

2. Related Art

For example, in a system such as a test apparatus which tests a device under test such as an IC or an LSI, a control device that controls a test module issues write access for changing a set value stored in a storage area of the test module or read access for referencing a set value, to the test module. The test module receives the write access or the read access from the control device, changes the set value stored in the storage area, and returns data including the set value as an access response to the control device. When the access response has been detected or an access response timeout has been detected, the control device issues the next access.

Japanese Patent Application Publication No. 2007-47008 is an example of the related art.

In such a system, it is possible to consider a method in which the next access is not issued until the control device receives the access response after issuing the read access to the test module. In this method, a waiting time may occur until the control device receives the access response from the test module after issuing the read access to the test module. In particular, the waiting time may occur even when it is not necessary for the access response to the read access to be reflected in the content of the next access to be issued by the control device.

### SUMMARY

Accordingly, it is an object of the present invention to provide a system, a test apparatus, and a relay apparatus, which are capable of solving the above-mentioned problems. This object may be achieved through the combination of features described in independent claims of the invention. Dependent claims thereof specify preferable embodiments of the invention.

According to a first embodiment of the present invention, there is provided a system comprising a requesting device which requests access; a responding device which processes the requested access; and a relay apparatus which relays communication between the requesting device and the responding device. The requesting device includes a block generating section which generates an access information block storing access information including a target address of an access target and an access command indicating content to be executed for the access target in each of a plurality of accesses; and a block transmitting section which transmits the generated access information block to the relay apparatus. The relay apparatus includes a block receiving section which receives the access information block from the requesting device; and an access issuing section which sequentially issues corresponding access to the responding device on the basis of the access information included in the transmitted access information block. The responding device includes an access receiving section which receives each access corresponding to the access information included in the access information block from the relay apparatus; and an access processing section which executes an access process designated by the access command for a storage area corresponding to a target address of the received access.

According to a second embodiment of the present invention, there is provided a test apparatus comprising a test module which exchanges a signal with a device under test; a control device which controls the test module; and a relay apparatus which controls communication between the control device and the test module, and tests the device under test. The control device includes a block generating section which generates an access information block storing access information including a target address of an access target and an access command indicating content to be executed for the access target for each of a plurality of accesses; and a block transmitting section which transmits the generated access information block to the relay apparatus. The relay apparatus includes a block receiving section which receives the access information block from the control device; and an access issuing section which sequentially issues corresponding access to the test module on the basis of the access information included in the transmitted access information block. The test module includes an access receiving section which receives each access corresponding to the access information included in the access information block from the relay apparatus; and an access processing section which executes an access process designated by the access command for a storage area corresponding to a target address of the received access.

According to a third embodiment of the present invention, there is provided a relay apparatus that relays communication between a requesting device which requests access and a responding device which processes the requested access, comprising a block receiving section which receives an access information block, storing access information including a target address of an access target and an access command indicating content to be executed for the access target for each of a plurality of accesses, from the requesting device; and an access issuing section which sequentially issues corresponding access to the responding device on the basis of the access information included in the transmitted access information block.

The summary of the invention does not necessarily describe all necessary features of the embodiments of the present invention. The invention may also be a sub-combination of the features described above.

### BRIEF DESCRIPTION OF THE DRAWINGS

FIG. 1 shows the configuration of a test apparatus 10 according to this embodiment along with a device under test 500.

FIG. 2 shows an example of the configuration of a control device 100.

FIG. 3 shows an example of the configuration of a relay apparatus 200.

FIG. 4 shows an example of the configuration of a test module 300-1, which is representative of test modules 300.

FIG. 5 shows an example of an access information block 20 to be transmitted from a block transmitting section 120 of the control device 100 to a block receiving section 210 of the relay apparatus 200.

FIG. 6 shows a flowchart of an access process when the access information block 20 shown in FIG. 5 is transmitted.

### DESCRIPTION OF EXEMPLARY EMBODIMENTS

The invention will now be described through embodiments thereof. The embodiments do not limit the invention according to claims. All of the features and the combinations thereof described in the embodiments are not necessarily essential to the invention.

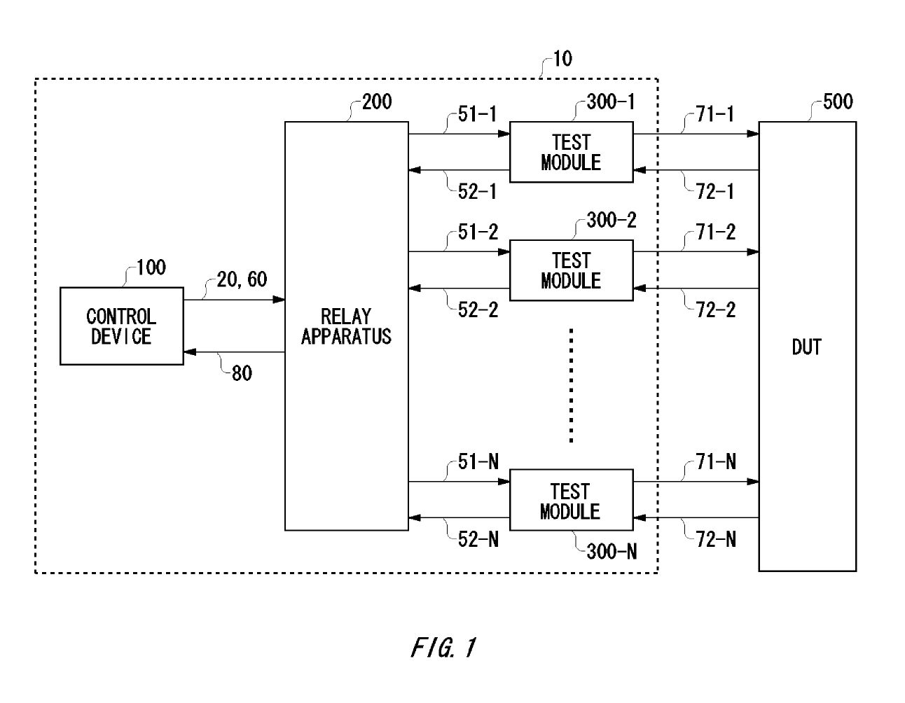

FIG. 1 shows the configuration of a test apparatus 10 according to this embodiment along with a device under test 500. For example, the test apparatus 10 is a device for testing the device under test 500 such as an IC, an LSI, or a memory device. The test apparatus 10 includes a control device 100, a relay apparatus 200, and test modules 300 (for example, 300-1 to 300-N (N is a positive integer)). The control device 100 controls the test modules 300. The relay apparatus 200 controls communication between the control device 100 and the test modules 300. The test modules 300 exchange signals with the device under test 500.

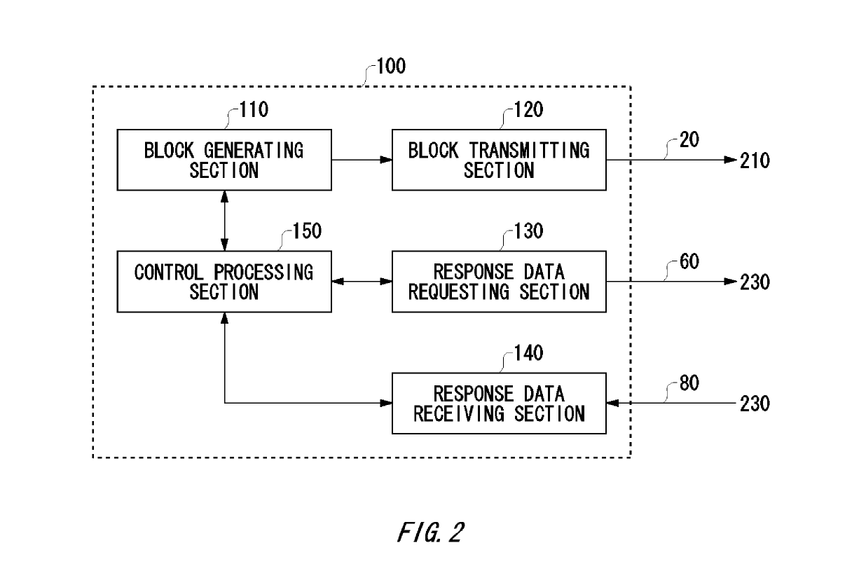

FIG. 2 shows an example of the configuration of the control device 100. The control device 100 has a block generating section 110, a block transmitting section 120, a response data requesting section 130, a response data receiving section 140, and a control processing section 150. For example, the control device 100 is connected to each of the test modules 300 via the relay apparatus 200 by a high-speed communication line such as a Gbit Ethernet (registered trademark). For example, the control device 100 collectively controls the test modules 300 or individually controls at least one thereof.

For example, the control processing section 150 executes a test program indicated by an operation input by a user of the test apparatus 10. For example, the test program to be executed by the control processing section 150 may be a program for transmitting various accesses to the test modules 300, including write access for writing data to set a function/operation for a storage area of the test modules 300, and read access for reading data such as setting data, a test result, and a diagnosis result written to a storage area of the test module 300. The control processing section 150 controls the block generating section 110, the response data requesting section 130, and the response data receiving section 140 of the control device 100 by executing the above-described program. The control processing section 150 may be arranged separately from the control device 100.

For example, the block generating section 110 generates an access information block 20 storing access information respectively corresponding to various accesses on the basis of an instruction command from the control processing section 150. Here, for example, the above-described access information includes a target address of an access target and an access command indicating content to be executed for the access target. Specifically, for example, access information corresponding to the write access may include a write command, a write target address, and write data. For example, access information corresponding to the read access may include a read command and a read target address. The block transmitting section 120 transmits the access information block 20 generated by the block generating section 110 to the relay apparatus 200. The response data requesting section 130 and the response data receiving section 140 will be described below in detail.

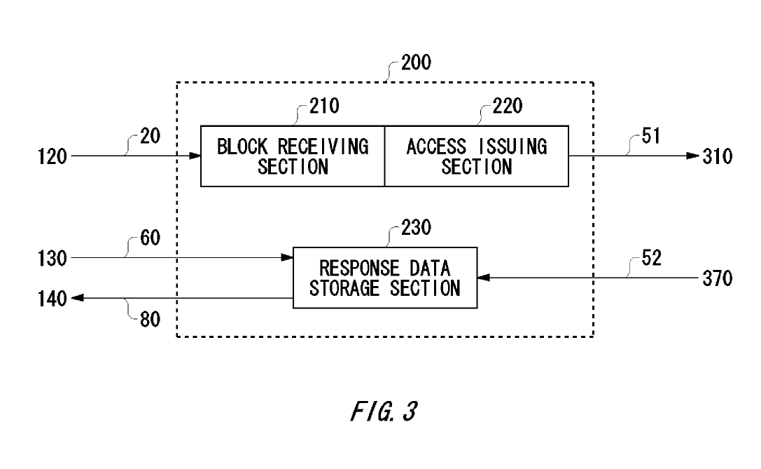

FIG. 3 shows an example of the configuration of the relay apparatus 200. The relay apparatus 200 is a device which controls communication between the control device 100 and each of the test modules 300. The relay apparatus 200 has a block receiving section 210, an access issuing section 220, and a response data storage section 230. For example, the relay apparatus 200 may be an extension board inserted into a PCI bus arranged on the control device 100.

The block receiving section 210 receives the access information block 20 transmitted by the block transmitting section 120 of the control device 100. The access issuing section 220 sequentially issues access 51 corresponding to each piece of access information to the test modules 300 by reading the access information included in the received access information block 20. At this time, the access issuing section 220 may broadcast the access 51 corresponding to the access information read from the access information block 20 to the test modules 300-1 to 300-N. In place thereof, the access issuing section 220 may detect a text module 300-X having a storage area corresponding to a target address on the basis of the target address included in the access information read from the access information block 20, and may issue access 51-X corresponding to the read access information to the test module 300-X. The response data storage section 230 will be described below in detail.

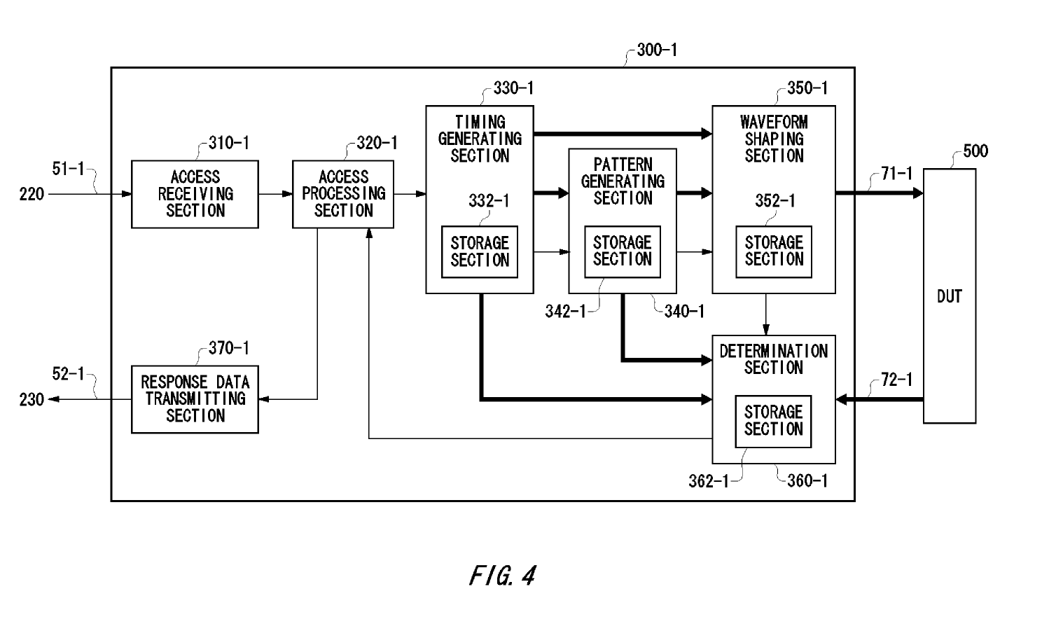

FIG. 4 shows an example of the configuration of the test module 300-1, which is representative of the test modules 300. The test module 300-1 has an access receiving section 310-1, an access processing section 320-1, a timing generating section 330-1, a pattern generating section 340-1, a waveform shaping section 350-1, a determination section 360-1, and a response data transmitting section 370-1 which are mutually connected in a ring shape. The test module 300-1 supplies a test signal 71-1 to the device under test 500, and receives a response signal 72-1 from the device under test 500.

The test module 300-1 has a storage section 332-1, a storage section 342-1, a storage section 352-1, and a storage section 362-1 respectively corresponding to the timing generating section 330-1, the pattern generating section 340-1, the waveform shaping section 350-1, and the determination section 360-1. The storage section 332-1, the storage section 342-1, the storage section 352-1, and the storage section 362-1 form the storage area of the test module 300-1. For example, the storage section 332-1, the storage section 342-1, the storage section 352-1, and the storage section 362-1 may each be a memory and/or a register mapped to a single address space.

The access receiving section 310-1 receives access 51-1 issued by the access issuing section 220 of the relay apparatus 200 and transmits the received access 51-1 to the access processing section 320-1. The access processing section 320-1 detects which of the storage section 332-1 of the timing generating section 330-1, the storage section 342-1 of the pattern generating section 340-1, the storage section 352-1 of the waveform shaping section 350-1, and the storage section 362-1 of the determination section 360-1 includes a storage area corresponding to a target address of the access 51-1 received by the access receiving section 310-1. A process designated by the access 51-1 is executed for the corresponding storage area.

More specifically, for example, when the access 51-1 is the write access to the storage section 352-1 within the waveform shaping section 350-1, the access processing section 320-1 transmits the access 51-1 to a storage area corresponding to a write target address within the storage section 352-1, thereby writing write data to the storage area. In this case, the access 51-1 may be transmitted to the waveform shaping section 350-1 through the timing generating section 330-1 and the pattern generating section 340-1.

For example, when the access 51-1 is the read access to the storage section 362-1 within the determination section 360-1, the access processing section 320-1 transmits the access 51-1 to a storage area corresponding to a read target address within the storage section 362-1, thereby reading data (hereinafter, referred to as “response data 52-1”) written to the storage area. In this case, the access 51-1 may be transmitted to the determination section 360-1 through the timing generating section 330-1, the pattern generating section 340-1, and the waveform shaping section 350-1.

The response data 52-1 read from the storage section 362-1 is transmitted to the access processing section 320-1. The response data 52-1 may be directly transmitted to the access processing section 320-1. In place thereof, the response data 52-1 may be transmitted to the access processing section 320-1 upstream in a path through which the access 51-1 has been transmitted from the access processing section 320-1 to the determination section 360-1. The access processing section 320-1 transmits the transmitted response data 52-1 to the response data transmitting section 370-1. The response data transmitting section 370-1 returns the response data 52-1 transmitted from the access processing section 320-1 to the response data storage section 230 of the relay apparatus 200.

The timing generating section 330-1 generates a cycle signal indicating a cycle in which a test pattern and an expected value are output, a timing signal indicating a timing of supplying a test signal 71-1 to the device under test 500, and a timing signal indicating a timing of sampling a response signal 72-1 from the device under test 500. For example, the timing generating section 330-1 outputs the cycle signal to the pattern generating section 340-1, outputs the timing signal indicating the timing of supplying the test signal 71-1 to the waveform shaping section 350-1, and outputs the timing signal indicating the timing of sampling the response signal to the determination section 360-1, on the basis of a timing designated by a reference clock provided from an outside source and a timing set signal from the pattern generating section 340-1.

The pattern generating section 340-1 generates the test signal 71-1 to be supplied to the device under test 500 and an expected value of the response signal 72-1 by executing a sequence of test pattern data designated by the user of the test apparatus 10. The test program may be pre-stored in the pattern storage section 342-1 by the control device 100. The pattern generating section 340-1 outputs the generated test pattern to the waveform shaping section 350-1 and outputs the expected value to the determination section 360-1 on the basis of the cycle of the cycle signal from the timing generating section 330-1.

The waveform shaping section 350-1 receives a timing signal for supplying the test pattern transmitted from the pattern generating section 340-1 and the test signal 71-1 transmitted from the timing generating section 330-1. On the basis of the above-described test pattern and the above-described timing signal received, the waveform shaping section 350-1 generates the test signal 71-1 and supplies the generated test signal 71-1 to the device under test 500.

For example, the determination section 360-1 compares the response signal 72-1 from the device under test 500 with the above-described expected value. The determination section 360-1 may store fail information indicating whether the response signal 72-1 is the same as or different from the expected value as the comparison result in the storage section 362-1.

The response data storage section 230 of the relay apparatus 200 stores the response data 52-1 returned from the response data transmitting section 370-1 of the test modules 300 in response to the access 51-1, which is the above-described read access. The response data requesting section 130 of the control device 100 requests the response data storage section 230 to transmit the response data 52-1 stored in the response data storage section 230 to the response data receiving section 140 of the control device 100 on the basis of an instruction command from the control processing section 150. The response data receiving section 140 receives the response data 52-1 transmitted from the response data storage section 230 in response to the request from the response data requesting section 130. The response data requesting section 130 may request the response data storage section 230 to transmit the response data 52-1 stored in the response data storage section 230 to the response data receiving section 140 by issuing the read access to the response data storage section 230.

When a plurality of pieces of response data 52-1 has been sequentially returned from the response data transmitting section 370-1, the response data storage section 230 may sequentially store the pieces of response data 52-1. The response data requesting section 130 requests the relay apparatus 200 to transmit the pieces of response data 52-1, stored in the response data storage section 230, as a response information block 80 to the response data receiving section 140 by collective DMA transmission. In response to the request from the response data requesting section 130, the relay apparatus 200 transmits the pieces of response data 52-1, stored in the response data storage section 230, as the response information block 80 to the response data receiving section 140 by collective DMA transmission.

In the test apparatus 10 of this embodiment as described above, a plurality of pieces of access information is capable of being collectively transmitted from the control device 100 to the relay apparatus 200, as an access information block. Pieces of response data sequentially returned from the test modules 300 are capable of being collectively transmitted from the relay apparatus 200 to the control device 100. Accordingly, even before the relay apparatus 200 receives an access response (response data) after issuing the read access to the test modules 300, the relay apparatus 200 is able to issue the next access to the test modules 300. Therefore, a waiting time until the relay apparatus 200 receives the access response from the test modules 300 after issuing the read access to the test modules 300 does not occur.

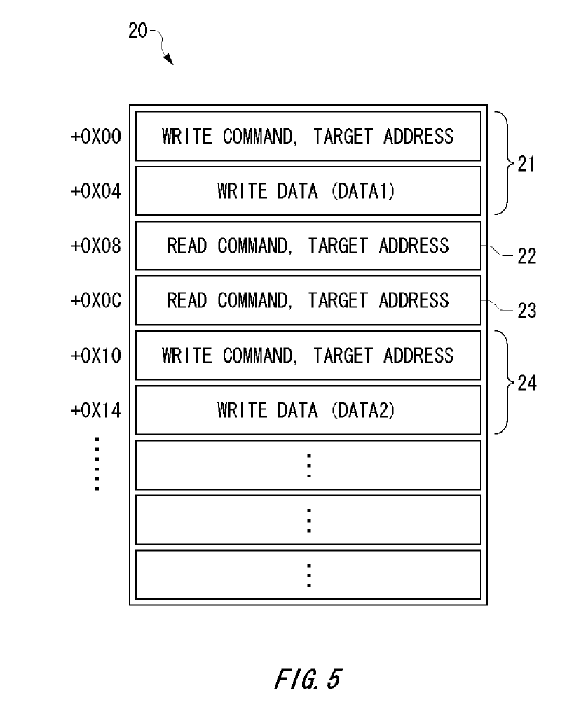

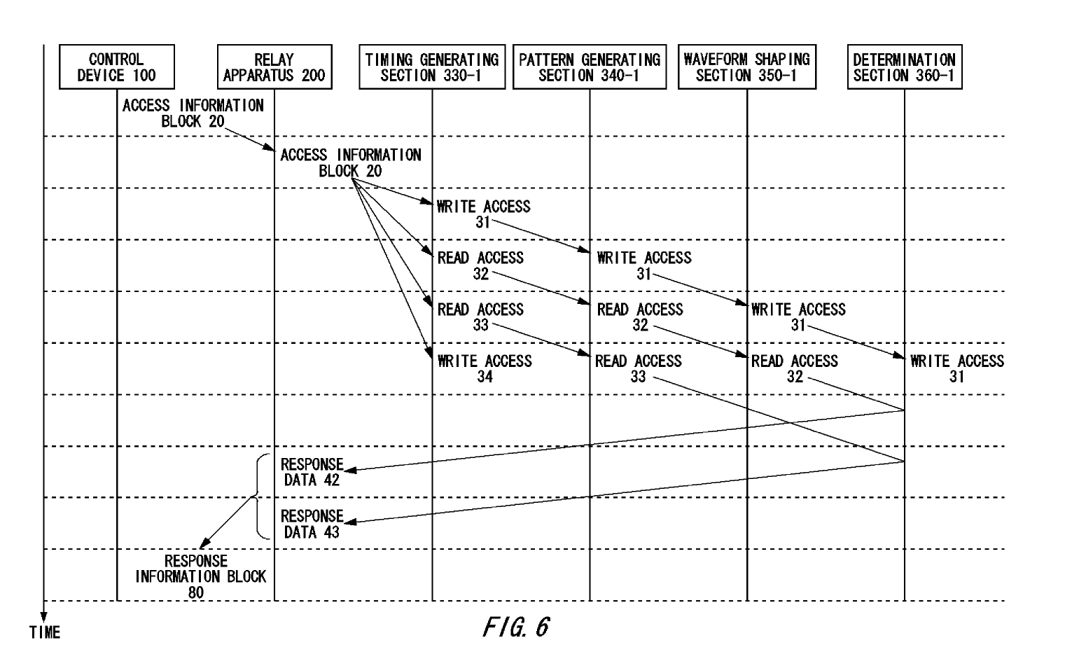

Hereinafter, an example of an access process in the control device 100, the relay apparatus 200, and the test module 300-1 of the test apparatus 10 of this embodiment will be described. FIG. 5 shows an example of an access information block 20 transmitted from the block transmitting section 120 of the control device 100 to the block receiving section 210 of the relay apparatus 200. FIG. 6 shows a timing chart of an access process when the access information block 20 shown in FIG. 5 has been transmitted.

The access information block 20 shown as an example in FIG. 5 stores a plurality of pieces of access information 21, 22, 23, and 24. Here, the access information 21 is information corresponding to the write access having the determination section 360-1 of the test module 300-1 as an access target. In this case, for example, the access information 21 may include 4-byte data indicating a target address as an access target within the storage section 362-1 of the determination section 360-1 and 4-byte data DATA1 indicating content to be written to the storage area. The access information 22 is information corresponding to the read access having the waveform shaping section 350-1 of the test module 300-1 as an access target. In this case, for example, the access information 22 may include 4-byte data indicating a target address as an access target within the storage section 352-1 of the waveform shaping section 350-1.

The access information 23 is information corresponding to the read access having the pattern generating section 340-1 of the test module 300-1 as an access target. In this case, the access information 23 may include 4-byte data indicating a target address as an access target within the storage section 342-1 of the pattern generating section 340-1. The access information 24 is information corresponding to the write access having the timing generating section 330-1 of the test module 300-1 as an access target. In this case, for example, the access information 24 may include 4-byte data indicating a target address as an access target within the storage section 332-1 of the timing generating section 330-1 and 4-byte data DATA2 indicating content to be written to the storage area.

When the access information block 20 including the plurality of pieces of access information 21, 22, 23, and 24 is transmitted from the block transmitting section 120 of the control device 100 to the block receiving section 210 of the relay apparatus 200, the access issuing section 220 of the relay apparatus 200 sequentially reads the access information 21, 22, 23, and 24 included in the access information block 20. The access issuing section 220 issues write access 31 corresponding to the access information 21 read from the access information block 20 to the determination section 360-1 of the test module 300-1. Accordingly, the above-described data DATA1 is written to the storage area of the access target within the storage section 362-1 of the determination section 360-1.

The access issuing section 220 issues the read access 32 corresponding to the access information 22 read from the access information block 20 to the waveform shaping section 350-1 of the test module 300-1. Accordingly, data written to the storage area of the access target within the storage section 352-1 of the waveform shaping section 350-1 is read.

The access issuing section 220 issues the read access 33 corresponding to the access information 23 read from the access information block 20 to the pattern generating section 340-1 of the test module 300-1. Accordingly, data written to the storage area of the access target within the storage section 342-1 of the pattern generating section 340-1 is read.

The access issuing section 220 issues write access 34 corresponding to the access information 24 read from the access information block 20 to the timing generating section 330-1 of the test module 300-1. Accordingly, the above-described data DATA2 is written to the storage area of the access target within the storage section 332-1 of the timing generating section 330-1.

Like the above-described response data 52-1, response data 42, which is data read from the above-described storage area of the storage section 352-1 in response to the read access 32, and response data 43, which is data read from the above-described storage area of the storage section 342-1 in response to the read access 33, are transmitted to the response data transmitting section 370-1 by the access processing section 320-1. The response data 42 and the response data 43 are returned to the response data storage section 230 of the relay apparatus 200 by the response data transmitting section 370-1. The response data storage section 230 stores the response data 42 and the response data 43 returned by the response data transmitting section 370-1 as the response information block 80.

In response to the request from the response data requesting section 130, the response data storage section 230 transmits the response information block 80 stored in the response data storage section 230 to the response data receiving section 140 by DMA transmission. Accordingly, the user is able to read data (the response data 42) written to the above-described storage area within the storage section 352-1 of the waveform shaping section 350-1 and data (the response data 43) written to the above-described storage area within the storage section 342-1 of the pattern generating section 340-1.

Although the invention has been described by way of the exemplary embodiments, it should be understood that those skilled in the art might make many changes and substitutions without departing from the spirit and scope of the invention. It is obvious from the definition of the appended claims that the embodiments with such modifications also belong to the scope of the invention.

The test apparatus 10 of this embodiment is an example of a system including a requesting device which requests access, a responding device which processes the requested access, and a relay apparatus which relays communication between the requesting device and the responding device. The control device 100 of the test apparatus 10 is an example of the requesting device in the above-described system.

The relay apparatus 200 of the test apparatus 10 is an example of the relay apparatus in the above-described system. The test modules 300 of the test apparatus 10 are an example of the responding device in the above-described system.

The relay apparatus may be an independent device connected to the requesting device and the responding device by a network. The requesting device and the responding device according to the present invention are not limited to a form in which the requesting device and the responding device are used within the test apparatus 10, and may be implemented as various requesting devices which request access and responding devices which process the requested access.

What is claimed is:

1. A system comprising:
a requesting device which requests access;
a responding device which processes the requested access; and
a relay apparatus which relays communication between the requesting device and the responding device, wherein
the requesting device includes:
a block generating section which generates an access information block storing access information including a target address of an access target and an access command indicating content to be executed for the access target in each of a plurality of accesses; and
a block transmitting section which transmits the generated access information block to the relay apparatus,
the relay apparatus includes:
a block receiving section which receives the access information block from the requesting device; and
an access issuing section which sequentially issues corresponding access to the responding device on the basis of the access information included in the transmitted access information block, and
the responding device includes:
an access receiving section which receives each access corresponding to the access information included in the access information block from the relay apparatus; and
an access processing section which executes an access process designated by the access command for a storage area corresponding to a target address of the received access.

2. The system according to claim 1,
wherein the access processing section reads data from the storage area corresponding to the target address in response to reception of read access indicating reading of data from the storage area corresponding to the target address, wherein
the responding device further includes a response data transmitting section which returns data, read in response to the read access, to the relay apparatus,
the relay apparatus further includes a response data storage section which stores response data returned from the responding device in response to the read access, and
the requesting device includes:
a response data requesting section which requests the relay apparatus to transmit the response data stored in the response data storage section to the requesting device; and
a response data receiving section which receives the response data transmitted from the relay apparatus in response to the request from the response data requesting section.

3. The system according to claim 2, wherein
the block transmitting section transmits the access information block to the relay apparatus by DMA transmission,
the response data requesting section requests the relay apparatus to transmit the response data stored in the response data storage section to the requesting device by DMA transmission, and
the relay apparatus transmits at least one piece of response data stored in the response data storage section by DMA transmission in response to the request from the response data requesting section.

4. The system according to claim 2, wherein
the response data requesting section issues read access to the response data storage section, and
the response data receiving section receives the response data read from the response data storage section in response to the read access.

5. The system according to claim 2, comprising a plurality of the responding devices respectively including storage areas with target addresses different from each other, wherein
the access issuing section broadcasts corresponding access to the plurality of responding devices on the basis of access information included in the transmitted access information block, and
the access processing section of each responding device executes an access process designated by the access command for the storage area when the responding device includes the storage area corresponding to the target address of the received access.

6. A test apparatus that tests the device under test, comprising:
a test module which exchanges a signal with a device under test;
a control device which controls the test module; and
a relay apparatus which controls communication between the control device and the test module, wherein
the control device includes:
a block generating section which generates an access information block storing access information including a target address of an access target and an access command indicating content to be executed for the access target for each of a plurality of accesses; and
a block transmitting section which transmits the generated access information block to the relay apparatus,
the relay apparatus includes:
a block receiving section which receives the access information block from the control device; and
an access issuing section which sequentially issues corresponding access to the test module on the basis of the access information included in the transmitted access information block, and
the test module includes:
an access receiving section which receives each access corresponding to the access information included in the access information block from the relay apparatus; and
an access processing section which executes an access process designated by the access command for a storage area corresponding to a target address of the received access.

7. A relay apparatus that relays communication between a requesting device which requests access and a responding device which processes the requested access, comprising:
a block receiving section which receives an access information block, storing access information including a target address of an access target and an access command indicating content to be executed for the access target for each of a plurality of accesses, from the requesting device; and
an access issuing section which sequentially issues corresponding access to the responding device on the basis of the access information included in the transmitted access information block.

8. The relay apparatus according to claim 7, wherein
the access issuing section further includes a response data storage section which stores response data to be read from a storage area corresponding to a target address in response to issuance of read access reading of data from the storage area corresponding to the target address and stores response data returned from the responding device, and
the response data is transmitted to the requesting device in response to reception of a transmission request of the response data stored in the response data storage section from the requesting device.
